(19) United States
(12) Patent Application Publication
(10) Pub. No.: US 2016/0136792 A1
(43) Pub. Date: May 19, 2016

(54) Double Ended Bit

(71) Applicant: Mike Harp, Lexington, KY (US)

(72) Inventor: Mike Harp, Lexington, KY (US)

(21) Appl. No.: 14/542,658

(22) Filed: Nov. 17, 2014

(51) Int. Cl. B25B 15/00; B25B 23/00; B25B 13/06

(52) U.S. Cl. CPC B25B 15/008; B25B 15/007; B25B 13/06; B25B 23/00

(57) ABSTRACT

The double bit in accordance with the present invention comprises a left axial extremity, an elongated barrel or axial center section and a right axial extremity. Each axial extremity is dimensioned and configured for engaging and associated chuck whereby a user can quickly switch tools by reversing the end of the double bit that engages the associated chuck. For example the double bit may have first and second sockets at the ends thereof that are different sizes.

### CROSS-REFERENCE TO RELATED APPLICATIONS

1. Technical Field

The present invention is directed generally to tools used by among others electricians and mechanics as well as other trades persons. More particularly, the present invention is directed to a double ended bit having unique features for use with a drill having a chuck for engaging the bit. Ordinarily, the bit in accordance with the present invention will be used with a power drill operated by an electric motor.

### 2. Background of the Invention

Craftsmen, including electricians and mechanics, are often required to repetitively engage multiple threaded fasteners such as bolts, screws and nuts of different types. For example, the craftsmen may engage a nut, a slotted screw, a bolt having an internal hexagonal drive surface or other type of fastener. In addition the craftsmen may be required to repetitively engage drive surfaces on fasteners having different sizes. Very often the craftsman may have a task utilizing an electric drill which requires repetitively switching between first and second bits that have respective first and second fastener engaging surfaces. Thus, the user must repetitively open the chuck of electric drill, remove the bit within the chuck, find a first bit having a first fastener engaging surface, engage the first bit with the chuck, tighten a first fastener followed by opening the chuck of the electric drill, removing the bit within the chuck, finding a second bit having a second fastener engaging surface, engaging the second bit with the chuck in tightening a second fastener. Said sequences and similar sequences over long periods of time are both fatiguing and time-consuming for the electrician or other craftsmen.

One example of such repetitive switching occurs when an electrician is installing wiring within a commercial or residential building causing the electrician to repetitively switch between respective tools.

From the above, it is therefore seen that there exists a need in the art to overcome the deficiencies and limitations described herein and above.

### SUMMARY OF THE INVENTION

The shortcomings of the prior art are overcome and additional advantages are provided through an elongated double bit which includes an elongated barrel having first and second axial extremities as well as first and second tools carried respectively on said elongated barrel at said first and second axial extremities thereof. Each of said first and second tools have a generally triangular outer surface having three generally planar faces thereof. Furthermore, each axial extremity is dimensioned and configured for entrance into an associated chuck.

In some embodiments the intersections of each one of the three generally planar faces with another of the three generally planar faces is rounded. Some embodiments have each of the first and second tools dimensioned and configured for engaging an associated threaded fastener. Other embodiments have only one of the first and second tools dimensioned and configured for engaging an associated threaded fastener. The first and second tools may both be sockets dimensioned and configured for engaging an associated fastener.

Some embodiments further include an axial section disposed intermediate one of the first and second tools and said barrel that provide indicia indicative of the characteristics of the first and second tools. One of the first and second tools may be a polygon shaped key which may have a hexagonal exterior shape. One of the first and second tools may be a screwdriver blade such a flat screwdriver blade.

Accordingly, it is an object of the present invention to provide a tool for use with an associated electric drill which allows the user to quickly swap between two different tools including switching between tools dimensioned and configured for different fastener types or sizes without the need to always search for an alternate bit.

It is another object of the present invention to provide a tool that will function in existing drill chucks.

It is yet another object of the present invention to provide a tool that maximizes the potential sizes that will engage existing chucks and thus minimizes the constraints on size inherent in any given chuck.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification.

The invention, however, both as to organization and method of practice, together with the further objects and advantages thereof, may best be understood by reference to the following description taken in connection with the accompanying drawings in which:

FIG. 1 is a side view of a preferred embodiment of the double bit in accordance with one form of the present invention.

FIG. 2 is another side view of the same embodiment of the double bit shown in FIG. 1 in which the bit has been rotated about the geometric axis thereof 60°.

FIG. 3 is another side view of the embodiment of the double bit shown in FIG. 1 in which the axial extremities are shown in section.

FIG. 4 is a left end view of the bit shown in FIG. 1.

FIG. 5 is a right end view of the bit shown in FIG. 1.

FIGS. 6 and 7 are illustrations of various fastener engaging drive members that may be utilized at the axial extremities of the double bit in accordance with various embodiments of the present invention.

FIG. 8 is an illustration of a drill bit that may be disposed at one of both axial extremities of the double bit in accordance with the present invention.

### DETAILED DESCRIPTION

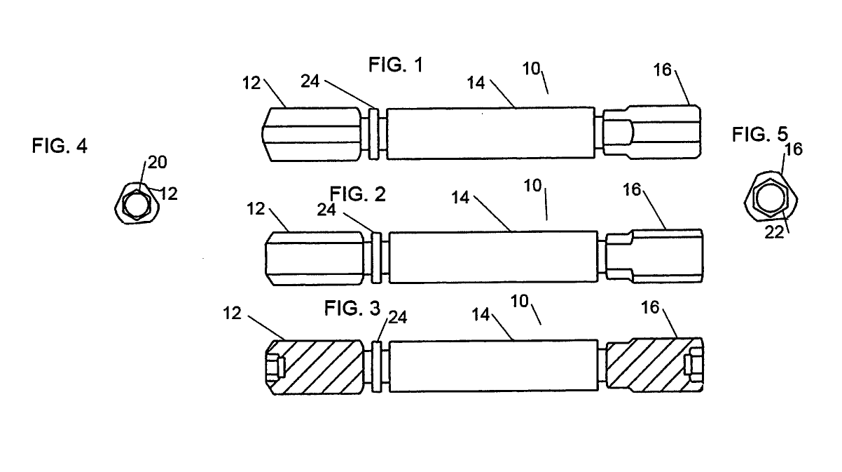

Referring now to FIGS. 1-5 there is shown an embodiment of the double bit apparatus in accordance with the present invention. More specifically, FIG. 1 is a side view of the double bit 10. FIG. 2 is another side view of the same embodiment of the double thick 10 in which the bit has been rotated about the geometric axis thereof by an angle of 60°. Similarly FIG. 3 is another side view of the embodiment of the double bit 10 in which the axial extremities are shown in section.

The double bit 10 comprises a left axial extremity 12, an elongated barrel or axial center section 14 and a right axial extremity 16. The cross-section of the barrel 14 may be round or a polygon in various embodiments. In the embodiment illustrated in FIGS. 1-5 the left axial extremity 12 includes a ¼ inch socket for loosening and tightening ¼ inch fasteners such as screws, bolts and nuts.

In the embodiment illustrated in FIGS. 1-5 the right axial extremity 16 includes a 5/16 inch socket for loosening and tightening 5/16 inch fastener such as screws, bolts and nuts. Each axial extremity 12, 16 has two functions. Thus when the ¼ inch hexagonal head axial extremity is in the chuck (not shown) the user can tighten 5/16 inch hexagonal head screws and bolts as well 5/16 inch nuts. When the 5/16 inch hexagonal head axial extremity is in the chuck (not shown) the user can tighten ¼ inch hexagonal head screws and bolts as well as ¼ inch nuts.

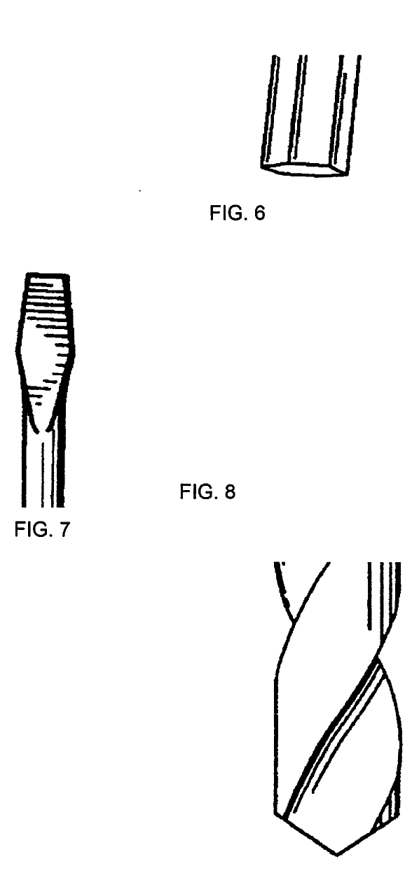

In a preferred embodiment the axial extremities 12, 16 of the double bit 10 have a substantially triangular outer surface as best seen in FIGS. 4 and 5. The intersections of the three respective sides of each axial extremity are preferably rounded as also shown in FIGS. 4 and 5. This generally polygon shape has two functions. First it minimizes the tendency of the double bit 10 to roll away from the user. In addition, the triangular shape cooperates best with the typical three jaw chuck whereby the largest possible bit is able to engage the conventional chuck.

FIGS. 6 and 7 are illustrations of exemplary fastener engaging drive members that may be utilized at the axial extremities of the double bit in accordance with various embodiments of the present invention. More specifically, these drawings respectively illustrate a hexagonal key, and a flat blade screwdriver blade.

FIG. 8 illustrates a drill bit that may be disposed at one axial extremity of the double bit. One embodiment of the present invention may utilize, for example, a drill bit on one axial extremity and a fastener engaging surface at the other axial extremity whereby the user might drill a pilot hole with one end and then use the other end to engage a fastener such as a wood screw or sheet metal screw with the pilot hole.

Some embodiments of the present invention may further include indicia which may indicate the size of the fastener engaging surface. For example, an axial part 24 disposed intermediate the barrel 14 and one of the axial sections 12, 16 may be part of the apparatus in accordance with the present invention. The axial part 24 is structured to facilitate placement of a color code thereon in a high speed production process. More particularly, an associated roller (not shown) may apply paint to the outer face of the axial part 24 without touching the recessed axially adjacent parts of the illustrated double bit 10.

Although the above description refers to a hexagonal socket in each of the axial extremities 12, 16 it will be understood that the sockets may be other polygon shapes sockets as well as other polygon shaped drive surfaces such as hexagonal keys, sometimes referred to as Allen wrenches, for turning a fastener. The term polygon as used herein includes triangles, squares and other multiple side structures including other regular polygons having all sides equal in size as well as a regular polygons. Similarly, other embodiments of the invention may have axial extremities of a screwdriver blade including but not limited to so-called Phillips screwdrivers as well as flat plate screwdrivers.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An elongated double bit which comprises:
an elongated barrel having first and second axial extremities;
first and second tools carried respectively on said elongated barrel at said first and second axial extremities thereof; each of said first and second tools having a generally triangular outer surface having three generally planar faces thereof and is dimensioned and configured to pass into an associated chuck.

2. The elongated double bit as described in claim 1 wherein the intersections of each one of said three generally planar faces with another of said three generally planar faces is rounded.

3. The elongated double bit as described in claim 1 wherein each of said first and second tools is dimensioned and configured for engaging an associated threaded fastener.

4. The elongated double bit as described in claim 1 wherein at least one of said first and second tools is dimensioned and configured for engaging an associated threaded fastener.

5. The elongated double bit as described in claim 1 further including an axial section disposed intermediate one of said first and second tools and said barrel, said axial section providing indicia indicative of the characteristics of said first and second tools.

6. The elongated double bit as described in claim 1 wherein said first and second tools are both sockets dimensioned and configured for engaging an associated fastener.

7. The elongated double bit as described in claim 1 wherein one of said first and second tools is a polygon shaped key.

8. The elongated double bit as described in claim 7 wherein said polygon shaped key has a hexagonal exterior shape.

9. The elongated double bit as described in claim 1 wherein one of said first and second tools is a screwdriver blade.

10. The elongated double bit as described in claim 9 wherein said screwdriver blade is a flat blade.
